(19) United States
(12) Patent Application Publication
(10) Pub. No.: US 2003/0212471 A1
(43) Pub. Date: Nov. 13, 2003

(54) System, method and apparatus for remote dispensing of items

(76) Inventor: Robindra Nath Chakravarti, Vancouver (CA)

Correspondence Address: DOWELL & DOWELL PC, SUITE 309, 1215 JEFFERSON DAVIS HIGHWAY, ARLINGTON, VA, 22202

(21) Appl. No.: 10/434,336

(22) Filed: May 9, 2003

Related U.S. Application Data
(60) Provisional application No. 60/379,473, filed on May 13, 2002.

(51) Int. Cl. G06F 17/00

(52) U.S. Cl. 700/241

(57) ABSTRACT

A system, apparatus and method for remotely dispensing items includes a controller and at least one remote dispenser. The controller includes an interface and a processor circuit. The interface receives information relating to a user and for receive from the user a request for a requested item having an item id. The processor circuit is in communication with the interface and is configured to associate a user id with the requested item, identify the at least one remotely located dispenser operable to dispense the requested item in response to the information relating to the user, and communicate the user id and the item id to the at least one remotely located dispenser when the requested item is available at the remotely located dispenser to permit the requested item to be retrieved from the at least one remotely located dispenser by the user.

### CROSS REFERENCE TO RELATED APPLICATIONS

This application claims priority from U.S. Provisional Patent Application No. 60/379,473, filed May 13, 2002.

### BACKGROUND OF THE INVENTION

1. Field of Invention

This invention relates to computer implemented methods for controlling the dispensing of returnable items and more particularly to methods for controlling dispensers remotely located from a central computer.

2. Description of Related Art

Public vending systems typically involve the use of a vending machine loaded with items potentially of interest to interested parties. Cigarette machines are a typical example of one type of public vending system.

Conventional public vending systems usually require that an interested party actually be present before the vending machine in order to make a selection. This is acceptable for familiar products, but for less familiar products an interested party may wish to have some time to explore the item requested.

Recent advances in computer technology have permitted items to be made available for sale or rent to interested parties using a computer network such as the internet, but typically, users are required to attend a pre-designated location to receive the item, or more expensively in cost or time, the item may be sent by courier or by mail. If a user is travelling however, it may not be possible to determine exactly when the user can receive the item and in the case of delivered items, someone would have to be available to receive the item on behalf of the requestor and hold it until the requestor arrives. This can be impractical and may add more cost and complexity to receiving the item.

The use of courier or mail delivery services is unsuitable for lower priced products, as the cost it adds is disproportional to the price. The use of courier or mail delivery services is also unsuitable for rental items, as the time, costs and inconvenience are doubled.

### SUMMARY OF THE INVENTION

In accordance with one aspect of the invention, there is provided a computer-implemented method for controlling a remote dispenser to dispense an item. The method involves receiving information relating to a user, receiving from the user a request for a requested item having an item id, associating a user id with the requested item, identifying at least one remotely located dispenser operable to dispense the requested item in response to the information relating to the user, and communicating the user id and the item id to the at least one remotely located dispenser when the requested item is available at the remotely located dispenser to permit the requested item to be retrieved from the at least one remotely located dispenser by the user.

The method may involve maintaining inventory records corresponding to respective inventory items operable to be dispensed, the inventory records including item id fields for identifying inventory items associated therewith and having status fields for holding codes indicating availability of corresponding inventory items.

The inventory records may be maintained by a record computer including at least one of a controller and the at least one remotely located dispenser.

The method may involve determining whether the requested item is available for dispensing and may involve querying the inventory records to locate a record corresponding to the requested item.

Querying may involve causing the record computer to read the status field of the record corresponding to the requested item to determine whether the item is available for dispensing.

The method may involve causing the availability of the requested item to be communicated to the user in response to the contents of the status field.

The method may involve causing the record computer to change the contents of the status field to indicate the item is reserved.

The method may involve charging an account associated with the user.

The method may involve receiving, from the at least one remotely located dispenser, a signal indicating the requested item has been dispensed and setting the contents of the status field of an inventory record associated with the requested item to indicate that the item has been dispensed.

The method may involve charging an account associated with the user in response to receipt of the signal indicating the requested item has been dispensed.

The method may involve receiving from a return device a signal indicating the requested item has been returned. The signal may identify the requested item.

The method may involve setting the contents of the status field to indicate the requested item has been returned.

The method may involve transmitting a list signal to the user to cause a list of items available for dispensing to be provided to the user. The list signal may be provided such that the list signal causes an identification of at least one dispenser at which the requested item is available to be identified to the user.

Receiving a request may involve receiving a message from a user computer.

In accordance with another aspect of the invention, there is provided a computer readable medium encoded with codes for directing a processor circuit to execute the method broadly described above and its various options.

In accordance with another aspect of the invention, there is provided a computer readable signal encoded with codes for directing a processor circuit to execute the method broadly described above and its various options.

In accordance with another aspect of the invention, there is provided an apparatus for controlling a remote dispenser to dispense an item, the apparatus including provisions for receiving information relating to a user, provisions for receiving from the user a request for a requested item having an item id, provisions for associating a user id with the requested item, provisions for identifying at least one remotely located dispenser operable to dispense the requested item in response to the information relating to the user, and provisions for communicating the user id and the item id to the at least one remotely located dispenser when the requested item is available at the remotely located dispenser to permit the requested item to be retrieved from the at least one remotely located dispenser by the user.

In accordance with another aspect of the invention, there is provided an apparatus for controlling a remote dispenser to dispense an item, the apparatus including an interface for receiving information relating to a user and for receiving from the user a request for a requested item having an item id, a processor circuit in communication with the interface, the processor circuit being configured to: associate a user id with the requested item, identify at least one remotely located dispenser operable to dispense the requested item in response to the information relating to the user, and communicate the user id and the item id to the at least one remotely located dispenser when the requested item is available at the remotely located dispenser to permit the requested item to be retrieved from the at least one remotely located dispenser by the user.

The apparatus may include a record computer configured to maintain inventory records corresponding to respective inventory items operable to be dispensed, the inventory records including item id fields for identifying inventory items associated therewith and having status fields for holding codes indicating availability of corresponding inventory items.

The record computer may include at least one of the processor circuit and the at least one remotely located dispenser.

The record computer may be configured to determine whether the requested item is available for dispensing.

The record computer may be configured to query the inventory records to locate a record corresponding to the requested item.

The record computer may be configured to read the status field of the record corresponding to the requested item to determine whether the item is available for dispensing.

The record computer may be configured to cause the availability of the requested item to be communicated to the user in response to the contents of the status field.

The record computer may be configured to change the contents of the status field to indicate the requested item is reserved.

The processor circuit may be configured to charge an account associated with the user in response to receipt of the availability signal.

The processor circuit may be configured to receive, from the at least one remotely located dispenser, a signal indicating the requested item has been dispensed.

The record computer may be configured to set the contents of the status field of an inventory record associated with the item dispensed to indicate that the item has been dispensed.

The record computer may be configured to charge an account associated with the user in response to receipt of the signal indicating the requested item has been dispensed.

The processor circuit may be configured to receive from a return device a signal indicating the requested item has been returned, the signal identifying the requested item.

The record computer may be configured to set the contents of the status field to indicate the requested item has been returned.

The interface may be configured to transmit a list signal to the user to cause a list of items available for dispensing to be provided to the user, the list signal including an identification of at least one dispenser at which the item is available to be identified to the user.

The interface may be configured to receive a message from a user computer.

In accordance with another aspect of the invention, there is provided a system for remotely dispensing items, the system including a controller and at least one remote dispenser. The controller includes an interface for receiving information relating to a user and for receiving from the user a request for a requested item having an item id. The controller also includes a processor circuit in communication with the interface, the processor circuit being configured to associate a user id with the requested item, identify the at least one remote dispenser in response to the information relating to the user, and to communicate the user id and the item id to the at least one remote dispenser when the requested item is available at the remote dispenser to permit the requested item to be retrieved from the at least one remote dispenser by the user.

In accordance with another aspect of the invention, there is provided a method of dispensing requested items at a location remote from a computer maintaining a record of requested items. The method involves receiving from the computer a user id and an item id associated with the user id, identifying an item requested by a user, receiving user input requesting the item, the user input including an identification of the user when the identification of the user matches the user id associated with the item id, dispensing the item and transmitting a signal to the computer to indicate the item has been dispensed, receiving the item and transmitting a signal to the computer in response to receiving the item, to indicate the item has been returned.

In accordance with another aspect of the invention, there is provided an apparatus for dispensing requested items at a location remote from a computer maintaining a record of requested items. The apparatus includes provisions for receiving from the computer a user id and an item id associated with the user id, identifying an item requested by a user, provisions for receiving user input requesting the item, the user input including an identification of the user, provisions for dispensing the item and transmitting a signal to the computer to indicate the item has been dispensed when the identification of the user matches the user id associated with the item id, provisions for receiving the item and means for transmitting a signal to the computer in response to receiving the item, to indicate the item has been returned.

The system permits a central computer to communicate with at least one of a plurality of remotely located dispensers, remotely located throughout a geographical area, for example, while permitting the central computer and/or dispensers to maintain records of the inventory of items for interrogation through a single, common location. It also facilitates reservation of items at a particular dispenser by a user without requiring the user to actually attend the site that will dispense the item and it permits user information to designate a dispenser at which the item is to be dispensed and permits the user to return the item to any site, not only the site from which the item was dispensed.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of a system for remotely dispensing items, according to a first embodiment of the invention;

FIG. 2 is a tabular representation of an inventory record maintained at both a controller and a dispenser of the system shown in FIG. 1;

FIG. 3 is a flowchart of a user access request routine executed by the controller shown in FIG. 1;

FIG. 4 is a flowchart of a reservation routine executed by the controller shown in FIG. 1;

FIG. 5 is a flowchart of a reservation routine executed by a dispenser shown in FIG. 1;

FIG. 6 is a flowchart of a dispensing routine executed by a dispenser shown in FIG. 1;

FIG. 7 is a flowchart of a dispense update routine executed by the controller shown in FIG. 1;

FIG. 8 is a flowchart of a return routine executed by a dispenser shown in FIG. 1;

FIG. 9 is a flowchart of a return update routine executed by the controller shown in FIG. 1.

### DETAILED DESCRIPTION

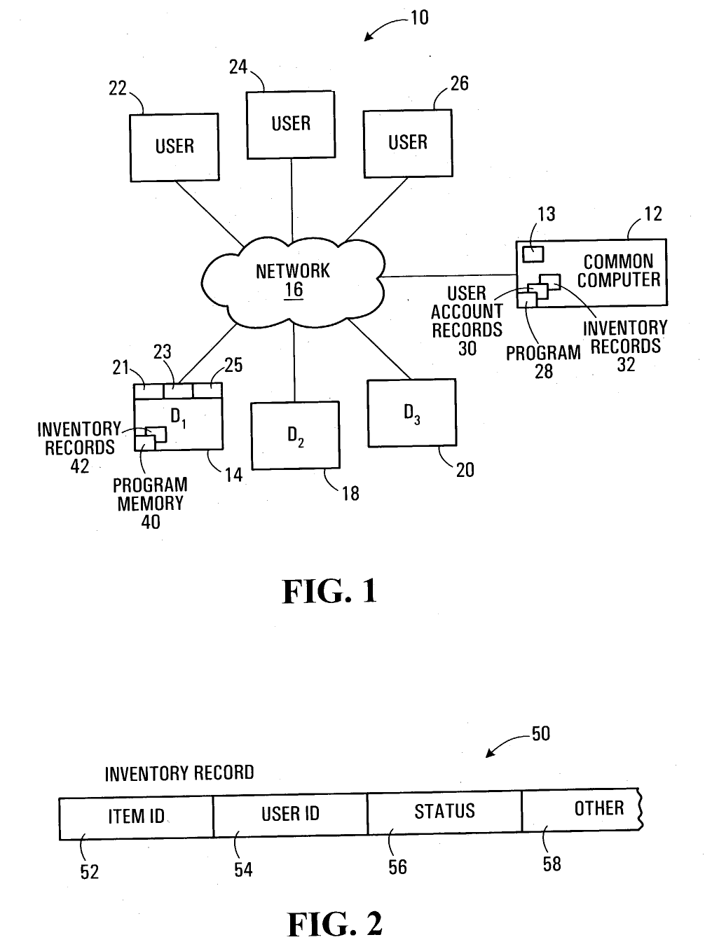

Referring to FIG. 1, a system for remotely dispensing items, according to a first embodiment of the invention, is shown generally at 10. The system includes a controller 12 and at least one remotely located dispenser 14 operable to communicate with each other through a network 16 which may, include a public switched telephone network, for example, or the Internet, for example. The system 10 may also include other dispensers 18 and 20 also operable to communicate with the controller 12 via the network 16.

The controller 12 is also operable to communicate with one or more user computers 22, 24 and 26, for example, using the network 16. It will be appreciated however, that the network used for communications between the controller 12 and the dispensers 14, 18, 20 may be different from the network used to provide for communications between the user computers 22, 24 and 26 and the controller 12. However, for convenience FIG. 1 shows use of a common network 16, in this case an Internet to facilitate these communications.

In effect, the controller 12 is operable to receive a request for an item from any one of the user computers 22, 24 or 26. The controller 12 then associates a user ID with the requested item and communicates the user ID and an item ID associated with the item to at least one dispenser 14, 18 or 20 operable to dispense the requested item. The controller may automatically determine which dispenser is nearest the requesting user or may receive information from the user indicating a particular one or more dispensers at which the user is likely to pick up the requested item. When the user picks up a requested item from a dispenser 14, 18 or 20, that dispenser sends to the controller a signal indicating the requested item has been dispensed to permit the controller to update inventory records maintained therein.

The user may return the requested item by returning the item to a designated return device which may include any of the dispensers 14, 18, 20 suitably configured to receive returned items and to transmit to the controller 12 a signal indicating the requested item has been returned to permit the inventory records to be updated at the controller.

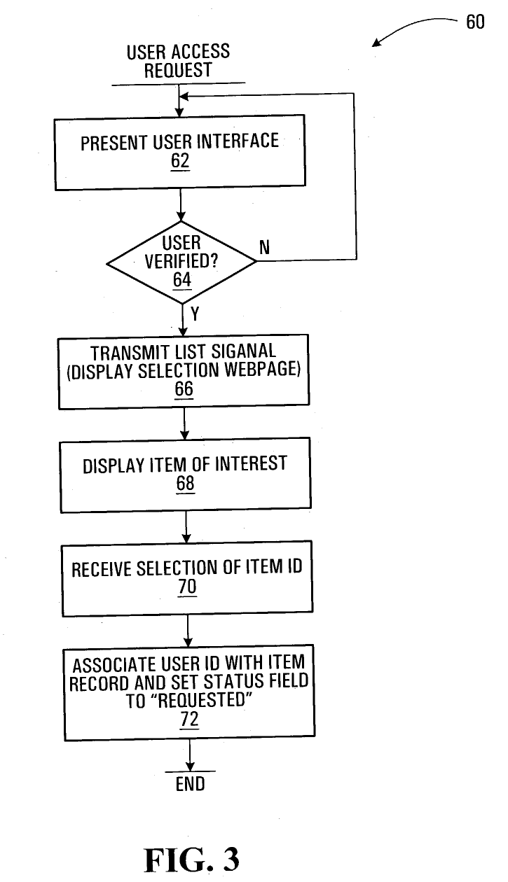

Still referring to FIG. 1, the controller 12 includes a processor circuit 13 and program memory 28 for storing programs that permit the controller to communicate with any of the user computers 22, 24 or 26 and to communicate with any of the dispensers 14, 18 or 20. These programs may include codes for implementing the routines shown in FIGS. 3, 4 and 7 and may be provided to the controller 12 by way of a computer readable medium such as an EPROM, CD ROM, or floppy disk, for example, or by way of a signal encoded with the codes. In addition, the controller 12 has memory 30 for storing user account records such as the user's name and address, password and identification and credit card information or other billing information, for example. In this embodiment, the controller also has memory 32 for storing inventory records relating to item inventory operable to be dispensed at the dispensers 14, 18 and 20.

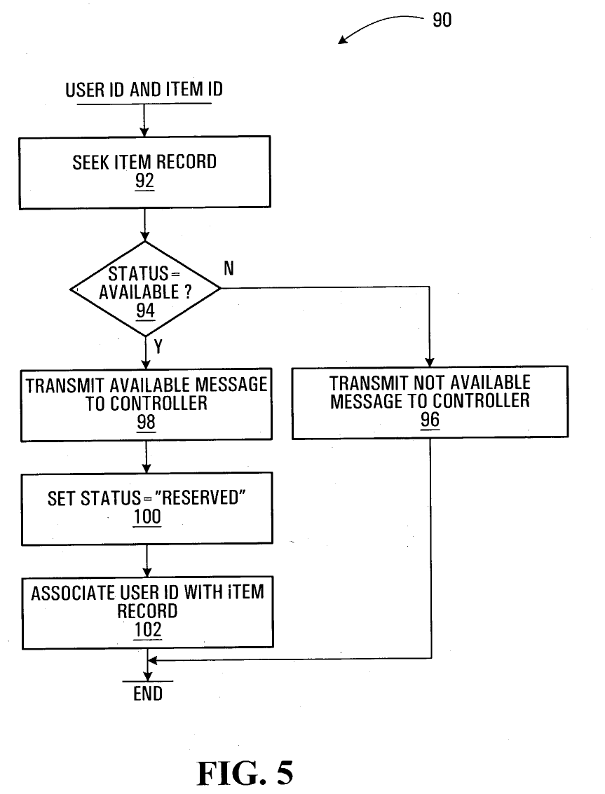

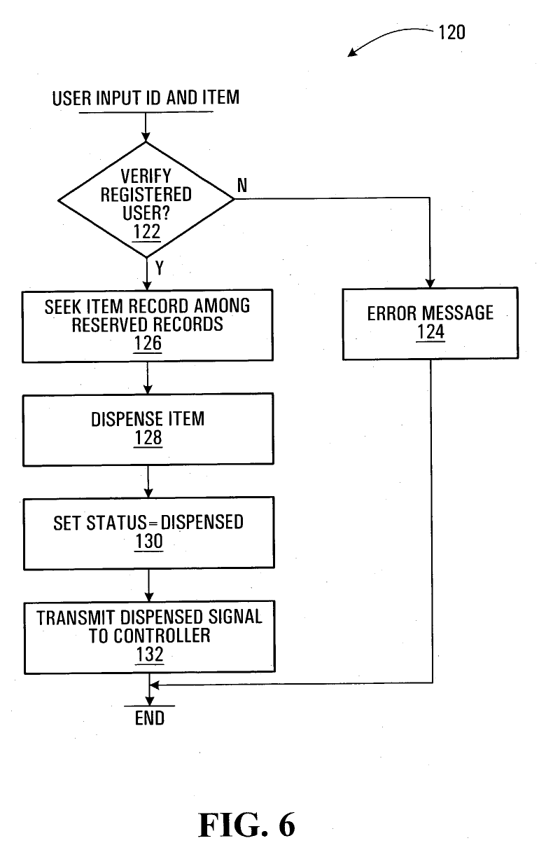

Each dispenser 14, 18 and 20 has its own built in computer 21 for controlling a dispensing mechanism 23 therein. Each or some of the dispensers may also have a detection mechanism 25 controlled by its built-in computer 21 for detecting return of items. The computer 21 includes program memory 40 for storing programs for directing the dispenser to carry out its functions and to cause it to communicate with the controller 12 and to cause it to maintain inventory records in an inventory memory 42, the inventory records relating to inventory of items operable to be dispensed at the associated dispenser, in this case, dispenser 14. Programs executed by the dispenser computers 21 may include codes for implementing the routines shown in FIGS. 5 and 6, for example, and may be provided to the controller 12 by way of a computer readable medium such as an EP ROM, CD ROM, or floppy disk, for example, or by way of a signal encoded with the codes.

Referring to FIG. 2, in this embodiment, both the controller 12 and the computers in the dispensers 14, 18 and 20 maintain inventory records of the type shown at 50 in FIG. 2. As will be explained below, either or both the controller and the dispensers may maintain inventory records. Whichever computer maintains the inventory records may be regarded as a “record computer”.

The inventory records include an item ID field 52, a user ID field 54, a status field 56 and may include “other” fields shown generally at 58. The item ID field 52 may be used to hold a code identifying the item with which the inventory record is associated. This code may also be represented on a barcoded sticker, for example, affixed to the item itself. The user ID field 54 may be set to a null value where the corresponding item is not reserved or dispensed and may be stored with a user ID value when the corresponding item is either reserved or dispensed to the associated user.

The status field 56 is used to indicate availability of the corresponding item by holding a code identifying whether or not the corresponding item is available, reserved or dispensed. The “other” field 58 may be used to store information such as a description of the item, identification of associated dispenser, dates on which the item was placed in service, dates on which the item was rented, etc., or any other information useful to an operator of the system.

Referring to FIG. 3, a flowchart of a process executed by the controller 12 in response to a user access request is shown generally at 60. The process begins in response to receipt of a user access request received from any of the user computers 22, 24 or 26. When such a request is received, the controller is interrupted and a computer program or subroutine comprised of codes represented by the flowchart shown in FIG. 3 is executed. At least some of these codes implement an interface for receiving information relating to the user and for receiving from the user a request for a requested item. More particularly, the codes include a first block 62 that directs the controller 12 to transmit a sign-on webpage to the requesting user computer. The user computer presents the user with a typical login screen that allows the user to enter a user ID and password, for example, which has been previously set up with the controller 12.

Next, block 64 directs the controller 12 to determine whether or not the user is verified as a registered user, by comparing the user input information provided by the user in response to the sign on webpage, with information stored in the user account memory 30 of FIG. 1. If the user is not verified, then the sign-on webpage is repeated and the user is prevented from accessing the system until and unless the user is verified. If the user is verified, then block 66 directs the controller to cause a list signal representing a display selection webpage to be transmitted to the user computer for viewing by the user. The display selection webpage may permit the user to select a particular dispenser, for example, or dispenser location so that block 68 may direct the controller to display a list of items of interest to the user and available for dispensing, i.e., those available at the selected dispenser or location. Alternatively, a display selection webpage at block 66 may include display selections according to title or category, for example, and may identify at least one dispenser at which items are available. In the case of a system in which the rented items are video tapes or digital video discs, the display selection webpage may list items by category such as western, drama, comedy, etc, for example.

In the embodiment shown, while a display of items available to the user is being shown to the user, block 70 directs the controller 12 to receive a selection of an item made by the user. This may be done by the user clicking on a hyperlink in the display produced at block 68, for example. The hyperlink may identify and associate the item of interest to the user with an item ID code. The selection of the hyperlink may initiate a process that locates among the inventory records 50 the item ID associated with the item selected by the user and block 72 directs the controller 12 to associate the user ID with the item selected by the user by storing a user id code in the user ID field 54 of the corresponding inventory record 50 stored in the inventory memory 32 shown in FIG. 1. In addition, block 72 inserts into the status field 56 of the inventory record shown in FIG. 2 a code indicating that the item has been requested.

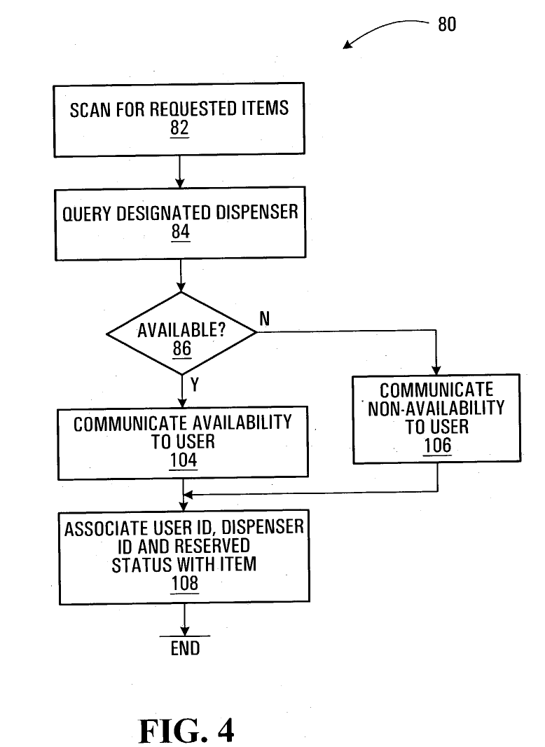

Referring to FIG. 4, the controller 12 runs a program that causes it to execute the process shown generally at 80 in FIG. 4, in the background. Alternatively the process shown at 80 may be initiated upon completion of block 72 shown in FIG. 3.

The process 80 is executed by the controller 12 by instructions in blocks of code stored in the program memory 28 at the controller. A first block 82 directs the controller 12 to scan the inventory records stored in the inventory memory 32 for records having a status field 56 with a “requested” code stored therein. Upon locating such a record, block 84 directs the controller 12 to query the designated dispenser, i.e., the dispenser designated by the user in response to the display of items of interest produced at block 68 in FIG. 3, to determine whether the requested item is available for dispensing. This, of course, assumes that the user has the freedom to select the dispenser from which the requested item should be dispensed. The system, however, may automatically determine the dispenser located nearest to the user or may use the user account records stored in the user account memory 30 to determine a preferred dispenser previously designated by the user. In any event, information relating to a dispenser at which the user will receive the dispensed item will be provided, received or read by the controller 12. In other words, the dispenser at which the user will receive the dispensed item is designated by the controller in response to information relating to the user.

Next, block 86 directs the controller 12 to wait for a signal from the designated dispenser indicating whether or not the item is available at that dispenser.

Referring to FIG. 5, the dispenser executes the routine shown at 90 to cause the “available” or “not available” signal to be sent to the controller 12 for receipt at block 86 in FIG. 4. The routine 90 is executed upon receipt of a user ID and an item ID transmitted to the dispenser at the query block 84 shown in FIG. 4.

Using the item ID, block 92 directs the computer 21 at the dispenser to query the inventory records to locate records having the item ID provided by the controller 12. On finding an associated record, block 94 directs the computer 21 to read the contents of the status field 56 in the record stored at the dispenser to determine whether or not it contains an “available” code indicating whether or not the corresponding item is available for dispensing. If the identified record does not have an “available” code stored in the status field 56, block 96 causes a “not available” signal to be transmitted to the controller. If, on the other hand, an “available” code is associated with the record, block 98 directs the dispenser computer 21 to transmit an “available” signal to the controller 12. After transmitting such signal, block 100 directs the dispenser computer 21 to store a code in the status field 56 of the corresponding record to indicate “reserved” status and block 102 directs the dispenser computer 21 to associate the user ID with the item record by storing the user ID received from the controller 12 in the user ID field 54 of the inventory record stored at the dispenser.

In an alternative embodiment, only the controller maintains inventory records and these records are associated with particular dispensers. The inventory records may have an additional field indicating a dispenser at which the corresponding item is available, for example. In such an embodiment, the controller need not query the dispenser to determine the availability of an item. Rather, instead of inserting a requested code in the status field of an inventory record in response to a request for the corresponding item, by a user, a direct search is initiated on the item id fields of all of the inventory records at the controller that are associated with the dispenser designated by the user information for records having a status field indicating the item is available. If no such records are found a “not available” signal is produced. If such a record is found, an available signal is produced.

Referring back to FIG. 4, on receipt of an. “available” signal from the controller 12 or the dispenser, block 104 directs the controller 12 to send a “reserved” signal to the user. Alternatively, if a “not available” signal is returned by the controller 12 or the dispenser, block 106 directs the controller 12 to send a “not available” signal to the user. Then, after completing either block 104 or 106, block 108 directs the controller 12 to associate the user ID and a reserved status code with the item, the reserved status code indicating whether or not the item is reserved or not available in response to said available and said not available signals. This association is achieved by storing the user ID and the reserved status code in the user ID field 54 and status field 56, respectively of the inventory record for the item, stored at the controller 12. Block 108 may also direct the controller 12 to store an identification of the dispenser in the “other” field 58 of the inventory record stored at the controller 12.

After reserving an item in the above manner, the controller 12 may then debit the user's account by making an appropriate entry into the corresponding user account record stored in the user account memory 30. Alternatively, debiting the user's account may be deferred until the item is actually dispensed to the user.

It will be appreciated that when an item has been reserved for dispensing at a particular dispenser, the corresponding item record at the dispenser, and at the controller includes a user ID and a status code indicating that the item has been reserved.

Referring to FIG. 6, when the user attends a site at which the designated dispenser is located, the designated dispenser computer 21 is operable to receive user input requesting the received item, causing the dispenser computer 21 to execute a routine as shown generally at 120 in FIG. 6. This routine begins with a first block 122 that directs the dispenser computer 21 to verify that the user input provided by the user is that of a properly registered user. If such information is not that of a registered user, then block 124 directs the dispenser computer 21 to cause an error message to be displayed to the user attending the designated dispenser. If the user input information is determined to be that of a registered user, block 126 directs the dispenser computer 21 to seek an item record among the inventory records having a status field 56 containing a code representing “reserved” status. Once the record has been found, block 128 directs the dispenser computer to cause the item to be dispensed and this may involve actuating the dispensing mechanism 23 to cause the item to be retrieved from a storage location and provided to a user. This may involve a simple vending machine type operation, or may involve a person delivering the item to the user. Next, block 130 directs the dispenser computer 21 to set the contents of the status field 56 of the inventory record at the dispenser to a code representing the item has been dispensed and block 132 directs the dispenser computer to transmit a “dispensed” signal containing an item id code to the controller 12.

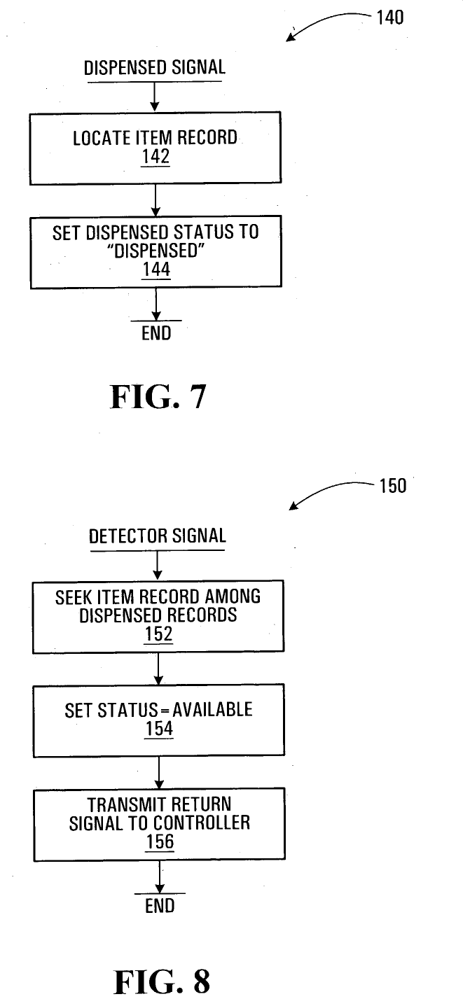

Referring to FIG. 7, a routine executed at the controller in response to receipt of the transmitted dispensed signal produced at block 132 of FIG. 6, is shown generally at 140 in FIG. 7. This routine includes a first block 142 that directs the controller 12 to locate the item record identified by the item ID code in the “dispensed” signal and block 144 directs the controller 12 to set the contents of the status field 56 of the inventory record for the item stored at the controller 12 to a code indicating that the item has been dispensed. Thus, inventory records at both the dispenser and at the controller 12 reflect that the item has been dispensed. The time of day of dispensing may be stored in the “other” fields 58, shown in FIG. 2, for example.

While the above description describes a system in which inventory records are stored at both the dispenser and at the controller 12, it Will be appreciated that the inventory records may be stored at a single location accessible by both the dispensers and the controller. This may be a separate database stored on a record computer that may include a separate computer or computers or computer memories, for example, and these may include or reside at the controller, one or more of the dispensers or on an entirely separate computer, for example.

Referring to FIG. 8, a process executed at a return device such as may be incorporated within a dispenser, for example, is shown generally at 150. In general, a return device includes a detector operable to identify an item being returned. The detector may include an RF tag reader for example, for reading an RF tag on the item being returned and/or it may include a barcode reader operable to read the barcode on the barcode sticker affixed to the dispensed item. The return device may include a receptacle for receiving the returned item and the receptacle may include a chute or mechanical arrangement for orienting the item such that the barcode can be read by a barcode reader in the return device. The barcode reader may produce a detector signal that includes a code indicating the item ID, decoded from the barcode on the barcode label on the item. In response to the detector signal, block 152 directs the return device, in this case the same dispenser that dispensed the item, to seek the inventory record associated with the returned item, from among records at the dispenser having status fields 56 indicating dispensed items. Block 154 then directs the dispenser computer 21 to set the contents of the status field 56 to reflect that the item is now available and, thus, the inventory record at the dispenser is updated with the available status of the item. Block 156 then directs the dispenser computer 21 to transmit a return signal containing the id code of the item returned, to the controller 12.

If the return device is not the same dispenser that dispensed the item, the return device simply transmits a return signal containing the id code of the item returned, to the controller 12.

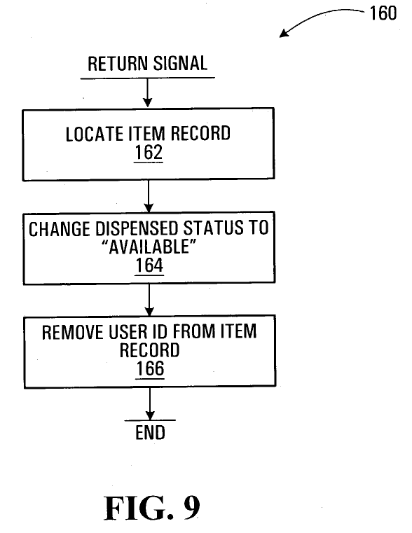

Referring to FIG. 9, a routine executed by the controller 12 in response to receipt of a return signal from the dispenser is shown generally at 160. This routine begins with a first block 162 that directs the controller 12 to locate the item record identified by the id code of the item returned, in the return signal. Block 164 directs the controller 12 to change the contents of the status field 56 of the located record to include a code indicating that the item is returned by resetting the contents of the status field to indicate the item is available. Block 166 then directs the controller 12 to remove the user ID from the user ID field 54 of the inventory record. The routine is then ended. Thus, the inventory records for the returned item are updated at the dispenser and at the controller 12 to indicate that the item is now available for re-dispensing.

Occasionally, items returned to return devices or dispensers that did not originally dispense the item may be gathered and re-distributed among dispensers in the system to balance inventories at each dispenser to maintain maximum availability of each item. To facilitate this the dispensers may have a “learn” mode in which in response to a signal received from a barcode reader, a new inventory record is produced to cause the item to be associated with the instant dispenser and to cause the instant dispenser to transmit a signal to the controller to indicate that the new record has been created at the dispenser. In response the controller finds any existing record for the item and re-associates it with the instant dispenser.

While specific embodiments of the invention have been described and illustrated, such embodiments should be considered illustrative of the invention only and not as limiting the invention.

What is claimed is:

1. A computer-implemented method for controlling a remote dispenser to dispense an item, the method comprising:
receiving information relating to a user;
receiving from the user a request for a requested item having an item id;
associating a user id with the requested item;
identifying at least one remotely located dispenser operable to dispense the requested item in response to said information relating to the user; and
communicating said user id and said item id to said at least one remotely located dispenser when said requested item is available at said remotely located dispenser to permit said requested item to be retrieved from said at least one remotely located dispenser by the user.

2. The method of claim 1 further comprising maintaining inventory records corresponding to respective inventory items operable to be dispensed, said inventory records including item id fields for identifying inventory items associated therewith and having status fields for holding codes indicating availability of corresponding inventory items.

3. The method of claim 2 wherein said inventory records are maintained by a record computer including at least one of a controller and said at least one remotely located dispenser.

4. The method of claim 2 further comprising determining whether said requested item is available for dispensing.

5. The method of claim 4 wherein determining comprises querying said inventory records to locate record corresponding to said requested item.

6. The method of claim 4 wherein querying comprises causing the record computer to read the status field of said record corresponding to said requested item to determine whether said item is available for dispensing.

7. The method of claim 6 further comprising causing the availability of said requested item to be communicated to the user in response to the contents of said status field.

8. The method of claim 6 further comprising causing the record computer to change the contents of said status field to indicate said item is reserved.

9. The method of claim 8 further comprising charging an account associated with the user.

10. The method of claim 2 further comprising receiving, from said at least one remotely located dispenser, a signal indicating said requested item has been dispensed.

11. The method of claim 10 further comprising setting the contents of the status field of an inventory record associated with said requested item to indicate that the item has been dispensed.

12. The method of claim 10 further comprising charging an account associated with the user in response to receipt of said signal indicating said requested item has been dispensed.

13. The method of claim 2 further comprising receiving from a return device a signal indicating said requested item has been returned.

14. The method of claim 13 wherein receiving said signal indicating said requested item has been returned comprises receiving a signal identifying said requested item.

15. The method of claim 14 further comprising setting the contents of said status field to indicate said requested item has been returned.

16. The method of claim 1 further comprising transmitting a list signal to the user to cause a list of items available for dispensing to be provided to the user.

17. The method of claim 16 further comprising producing said list signal such that said list signal causes an identification of at least one dispenser at which said requested item is available to be identified to the user.

18. The method of claim 1 wherein receiving a request comprises receiving a message from a user computer.

19. A computer readable medium encoded with codes for directing a processor circuit to execute the method claimed in claim 1.

20. A computer readable signal encoded with codes for directing a processor circuit to execute the method claimed in claim 1.

21. An apparatus for controlling a remote dispenser to dispense an item, the apparatus comprising:
means for receiving information relating to a user;
means for receiving from the user a request for a requested item having an item id;
means for associating a user id with the requested item;
means for identifying at least one remotely located dispenser operable to dispense the requested item in response to said information relating to the user; and
means for communicating said user id and said item id to said at least one remotely located dispenser when said requested item is available at said remotely located dispenser to permit said requested item to be retrieved from said at least one remotely located dispenser by the user.

22. An apparatus for controlling a remote dispenser to dispense an item, the apparatus comprising:
an interface for receiving information relating to a user and for receiving from the user a request for a requested item having an item id;
a processor circuit in communication with said interface, said processor circuit being configured to:
a) associate a user id with the requested item;
b) identify at least one remotely located dispenser operable to dispense the requested item in response to said information relating to the user; and
c) communicate said user id and said item id to said at least one remotely located dispenser when said requested item is available at said remotely located dispenser to permit said requested item to be retrieved from said at least one remotely located dispenser by the user.

23. The apparatus of claim 22 comprising a record computer configured to maintain inventory records corresponding to respective inventory items operable to be dispensed, said inventory records including item id fields for identifying inventory items associated therewith and having status fields for holding codes indicating availability of corresponding inventory items.

24. The apparatus of claim 23 wherein said record computer comprises at least one of said processor circuit and the at least one remotely located dispenser.

25. The apparatus of claim 24 wherein said record computer is configured to determine whether said requested item is available for dispensing.

26. The apparatus of claim 25 wherein said record computer is configured to query said inventory cords to locate a record corresponding to said requested item.

27. The apparatus of claim 26 wherein said record computer is configured to read the status field of said record corresponding to said requested item to determine whether said item is available for dispensing.

28. The apparatus of claim 27 wherein said record computer is configured to cause the availability of said requested item to be communicated to said user in response to the contents of said status field.

29. The apparatus of claim 27 wherein said record computer is configured to change the contents of said status field to indicate said requested item is reserved.

30. The apparatus of claim 30 wherein said processor circuit is configured to charge an account associated with the user in response to receipt of said availability signal.

31. The apparatus of claim 23 wherein said processor circuit is configured to receive, from said at least one remotely located dispenser, a signal indicating said requested item has been dispensed.

32. The apparatus of claim 31 wherein said record computer is configured to set the contents of the status field of an inventory record associated with said requested item dispensed to indicate that said requested item has been dispensed.

33. The apparatus of claim 31 wherein said record computer is configured to charging an account associated with the user in response to receipt of said signal indicating said requested item has been dispensed.

34. The apparatus of claim 22 wherein said processor circuit is configured to receive from a return device a signal indicating said requested item has been returned, said signal identifying said requested item.

35. The apparatus of claim 34 wherein said record computer is configured to set the contents of said status field to indicate said requested item has been returned.

36. The apparatus of claim 22 wherein said interface is configured to transmit a list signal to the user to cause a list of items available for dispensing to be provided to the user, said list signal including an identification of at least one dispenser at which said item is available to be identified to the user.

37. The apparatus of claim 22 wherein said interface is configured to receive a message from a user computer.

38. A system for remotely dispensing items, the system comprising:
a controller and at least one remote dispenser,
said controller including:
an interface for receiving information relating to a user and for receiving from the user a request for a requested item having an item id;
a processor circuit in communication with said interface, said processor circuit being configured to:
a) associate a user id with the requested item;
b) identify said at least one remotely located dispenser operable to dispense the requested item in response to said information relating to the user; and
c) communicate said user id and said item id to said at least one remotely located dispenser when said requested item is available at said remotely located dispenser to permit said requested item to be retrieved from said at least one remotely located dispenser by the user.

39. A method of dispensing requested items at a location remote from a computer maintaining a record of requested items, the method comprising:
receiving from the computer a user id and an item id associated with the user id, identifying an item requested by a user;
receiving user input requesting said item, said user input including an identification of the user
when said identification of the user matches said user id associated with said item id, dispensing said item and transmitting a signal to said computer to indicate said item has been dispensed;
receiving said item; and
transmitting a signal to said computer in response to receiving said item, to indicate said item has been returned.

40. An apparatus for dispensing requested items at a location remote from a computer maintaining a record of requested items, the apparatus comprising:
means for receiving from the computer a user id and an item id associated with the user id, identifying an item requested by a user;
means for receiving user input requesting said item, said user input including an identification of the user
means for dispensing said item and for transmitting a signal to said computer to indicate said item has been dispensed when said identification of the user matches said user id associated with said item id;
means for receiving said item; and
means for transmitting a signal to said computer in response to receiving said item, to indicate said item has been returned.
